(19) United States
(12) Patent Application Publication
(10) Pub. No.: US 2015/0189057 A1
(43) Pub. Date: Jul. 2, 2015

(54) VEHICLE AND METHOD FOR ACTIVATING VOICE CONTROL FUNCTION OF MOBILE PHONE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-HUA HSU, New Taipei (TW); ZHI-KAI TIAN, Shenzhen (CN); TAO LIN, Shenzhen (CN)

(21) Appl. No.: 14/579,268

(22) Filed: Dec. 22, 2014

(30) Foreign Application Priority Data
Dec. 27, 2013 (CN) 201310731779.X

(51) Int. Cl. H04M 1/60; H04W 4/02; H04W 4/04; H04W 8/22

(52) U.S. Cl. CPC H04M 1/6075; H04W 8/22; H04W 4/027; H04W 4/046

(57) ABSTRACT

A method for activating a voice control function of a mobile phone communicating with and carried in a vehicle is provided. The method includes the following steps. A sensing unit arranged in the vehicle senses a real-time speed of the vehicle when the vehicle is moving. A processor of the vehicle determines whether a real-time speed of the vehicle exceeds a predefined speed according to the sensed real-time speed of the vehicle. The processor controls the mobile phone to activate the voice control function of the mobile phone if the speed of the vehicle exceeds a predefined speed. A vehicle using the method is also provided by the present disclosure.

### CROSS-REFERENCE TO RELATED APPLICATIONS

This application claims priority to Chinese Patent Application No. 201310731779.X filed on Dec. 27, 2013, the contents of which are incorporated by reference herein.

### FIELD

The subject matter herein generally relates to vehicles, and particularly to a vehicle and a method for activating a voice control function of a mobile phone while being carried in the vehicle.

### BACKGROUND

Mobile phones are popular in daily life and work. A user typically uses a mobile phone with one hand while looking at the display of the mobile phone. Such usage of mobile phones is dangerous while driving a vehicle.

### BRIEF DESCRIPTION OF THE DRAWINGS

Implementations of the present technology will now be described, by way of example only, with reference to the attached figures.

FIG. 1 shows a block diagram of a vehicle and a mobile phone communicating with the vehicle in accordance with an exemplary embodiment.

FIG. 2 is a flowchart of an embodiment of a method for activating voice control function of the mobile phone of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to a vehicle and a method for activating a voice control function of a mobile phone communicating with and carried in a vehicle. The method comprising the following steps. A sensing unit arranged in the vehicle, senses a real-time speed of the vehicle when the vehicle is moving. A processor of the vehicle determines whether a speed of the vehicle exceeds a predefined speed according to the sensed real-time speed of the vehicle. The processor controls the mobile phone to activate the voice control function of the mobile phone if the speed of the vehicle exceeds a predefined speed.

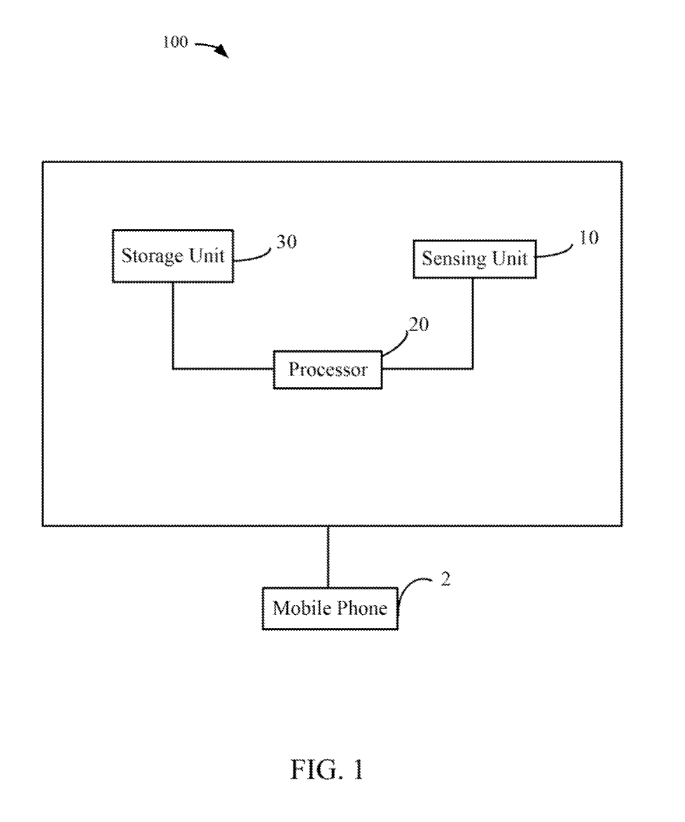

FIG. 1 illustrates a block diagram of an example vehicle 100 of the present disclosure. The vehicle 100 can be a car, a bus, a motorbike, etc. The vehicle 100 can include a sensing unit 10, a processor 20, and a storage unit 30. The vehicle 100 can communicate with a mobile phone 2 carried in the vehicle 100 wirelessly or wired. In at least one embodiment, the mobile phone 2 has hands-free and voice control function. In alternative embodiments, the mobile phone 2 can include more or fewer components than illustrated, or have a different configuration of the various components.

The sensing unit 10 can be configured to sense a real-time speed of the vehicle 100, and transmit the sensed real-time speed to the processor 20 when the vehicle 100 is moving. In at least one embodiment, the sensing unit 10 can be arranged on one or more axial of the vehicle 100. The sensing unit 10 can be a speed sensor or other speed sensing apparatus such as an acceleration sensor, etc.

The processor 20 is used to execute applications, such as programs installed in the vehicle 100 for implementing the method for activating voice control function of the mobile phone 2. The storage unit 30 can store one or more programs, such as the programs installed in the vehicle 100 for implementing the method for activating voice control function of the mobile phone 2 and applications of the vehicle. The storage unit 30 can be a storage card, such as a memory stick, a smart media card, a compact flash card, a secure digital card, or any other type of memory storage device.

The processor 20 can be configured for determining whether a speed of the vehicle 100 exceeds a predefined speed according to the sensed real-time speed of the vehicle 100. The processor 20 can be configured for sending a control signal to the mobile phone 2, if the real-time speed of the vehicle 100 exceeds a predefined speed.

The mobile phone 2 can automatically activate the voice control function when receiving the control signal sent from the processor 20. The mobile phone 2 can identify voice commands from a user and control the mobile phone 2 to execute corresponding functions according to the identified voice commands. In at least one embodiment, the user is a driver of the vehicle 100. When an incoming call is received, the mobile phone 2 can automatically answer the phone call in response to a voice command from the driver, such as “answer the phone”.

In an alternative embodiment, when the voice control function of the mobile phone 2 is activated, the mobile phone 2 also automatically plays a voice message or displays a text message on a display of the mobile phone 2 to prompt the user that the voice control function of the mobile phone 2 is activated.

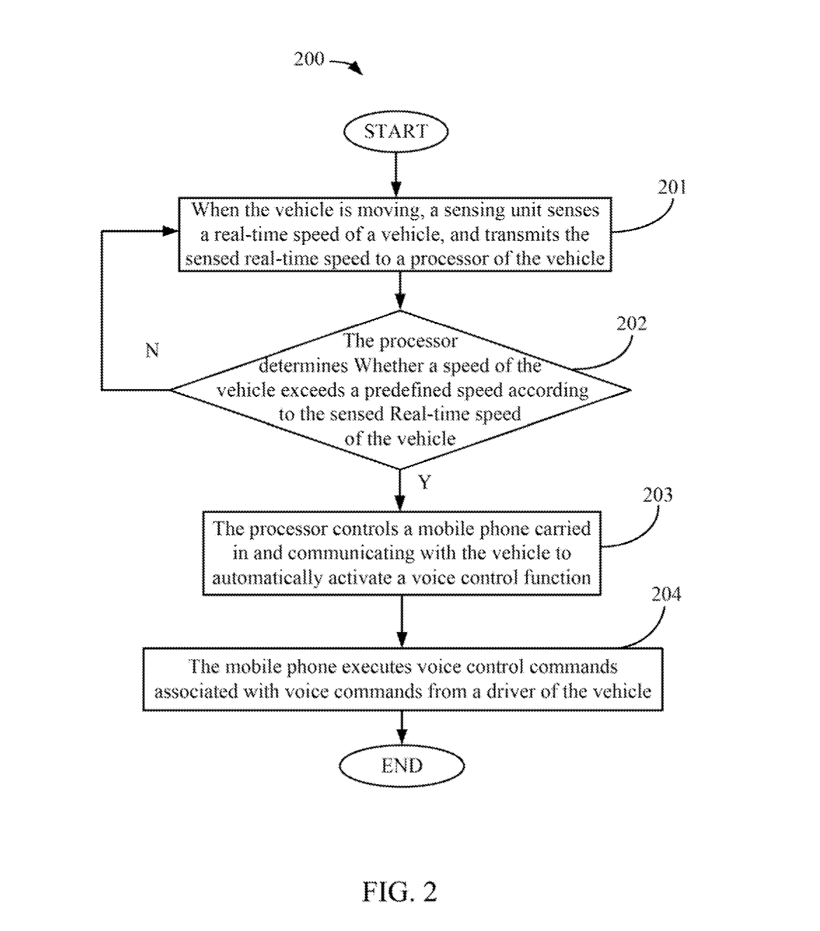

Referring to FIG. 2, a flowchart is presented in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or routines, carried out in the exemplary method 200. Furthermore, the illustrated order of blocks is by example only and the order of the blocks can be changed. Additional blocks may be added or fewer blocks may be utilized, without departing from this disclosure. The exemplary method 200 can begin at block 201.

At block 201, when the vehicle is moving a sensing unit senses a real-time speed of a vehicle and transmits the sensed real-time speed to a processor of the vehicle.

At block 202, the processor determines whether a speed of the vehicle exceeds a predefined speed according to the sensed real-time speed of the vehicle. If yes, block 203 is executed, otherwise, the process returns back to execute block 201.

At block 203, the processor controls a mobile phone carried in and communicating with the vehicle to automatically activate a voice control function.

In at least one embodiment, when the voice control function of the mobile phone 2 is activated, the mobile phone 2 automatically plays a voice message or displays a text message on a display of the mobile phone 2 to prompt the user that the voice control function of the mobile phone 2 is activated.

At block 204, the mobile phone executes voice control commands associated with voice commands from a driver of the vehicle.

The embodiments shown and described above are only examples. Many details are often found in the art such as the other features of a vehicle and a method thereof for activating a voice control function of a mobile phone. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. A method for activating a voice control function of a mobile phone communicating with a vehicle, the method comprising:
sensing, by a sensing unit arranged on the vehicle, a real-time speed of the vehicle when the vehicle is moving;
determining, by a processor of the vehicle, whether a real-time speed of the vehicle exceeds a predefined speed according to the real-time speed of the vehicle; and
controlling, by the processor, the mobile phone to activate the voice control function of the mobile phone if the speed of the vehicle exceeds the predefined speed.

2. The method as claimed in claim 1, further comprising:
controlling the mobile phone to play a voice message to prompt a user that the voice control function of the mobile phone is activated.

3. The method as claimed in claim 1, further comprising:
controlling the mobile phone to display a text message on a display of the mobile phone to prompt the user that the voice control function of the mobile phone is activated.

4. The method as claimed in claim 1, wherein the sensing unit is arranged on one or more shaft of the tires of wheels of the vehicle.

5. The method as claimed in claim 1, wherein the sensing unit is a speed sensor.

6. A vehicle comprising:
a sensing unit, for sensing a real-time speed of the vehicle when the vehicle is moving;
a storage unit;
a processor, for executing one or more programs stored in the storage unit to:
determine whether a speed of the vehicle exceeds a predefined speed according to the sensed real-time speed of the vehicle; and
control the mobile phone to activate a voice control function of a mobile phone communicating with the vehicle if the speed of the vehicle exceeds a predefined speed.

7. The vehicle as claimed in claim 6, wherein the processor further executes one or more programs stored in the storage unit to control the mobile phone to play a voice message to prompt a user that the voice control function of the mobile phone is activated.

8. The vehicle as claimed in claim 6, wherein the processor further executes one or more programs stored in the storage unit to control the mobile phone to display a text message on a display of the mobile phone to prompt the user that the voice control function of the mobile phone is activated.

9. The vehicle as claimed in claim 6, wherein the sensing unit is arranged on one or more shaft of the tires of wheels of the vehicle.

10. The vehicle as claimed in claim 6, wherein the sensing unit is a speed sensor.
